(19) United States
(12) Patent Application Publication
(10) Pub. No.: US 2025/0162839 A1
(43) Pub. Date: May 22, 2025

(54) AUTOMATIC STEP CLEANING DEVICE FOR PASSENGER CONVEYOR AND PASSENGER CONVEYOR

(71) Applicant: Otis Elevator Company, Farmington, CT (US)

(72) Inventor: Wenjun Pan, Hangzhou (CN)

(21) Appl. No.: 18/952,249

(22) Filed: Nov. 19, 2024

(30) Foreign Application Priority Data
Nov. 22, 2023 (CN) 202311576480.1

(51) Int. Cl. B66B 31/00; B66B 21/04; B66B 23/02

(52) U.S. Cl. CPC B66B 31/003; B66B 21/04; B66B 23/024

(57) ABSTRACT

An automatic step cleaning device for a passenger conveyor and a passenger conveyor are disclosed. The automatic step cleaning device is provided for a passenger conveyor in which a step chain is in transmission connection with a drive chain to receive power from a drive portion for driving steps to operate, which includes: a base, arranged adjacent to a step that is in a flipped state during operation; a rotating shaft, mounted on the base and arranged in the drive chain to be driven to rotate synchronously with the step chain; and a first cleaning member, mounted on the rotating shaft and configured to perform a cleaning operation on the steps currently passing through the rotating shaft in a flipped state when the rotating shaft is driven to rotate.

### FOREIGN PRIORITY

This application claims priority to Chinese Patent Application No. 202311576480.1, filed Nov. 22, 2023, and all the benefits accruing therefrom under 35 U.S.C. § 119, the contents of which in its entirety are herein incorporated by reference.

### TECHNICAL FIELD OF INVENTION

The present disclosure relates to a conveyor system, in particular to an automatic step cleaning device for a passenger conveyor and a passenger conveyor.

### BACKGROUND OF THE INVENTION

At present, various passenger conveyors such as escalators and moving walks have been widely used in many places, which bring great convenience to people's work, production, and travel. Nevertheless, the present application finds that improvements can still be made in certain aspects of the existing passenger conveyor products. For example, passenger conveyors need to be regularly cleaned during use. Currently, workers are usually arranged to perform manual cleaning. For example, works are arranged to clean debris, dust, or stains in areas such as on tread plates of steps, using brooms, mops, or vacuum cleaners according to preset time cycles. During the cleaning period, the equipment often needs to be shut down. In addition, although in the prior art, some passenger conveyors have been equipped with specialized cleaning devices in some application scenarios, such devices have problems such as being unable to achieve satisfactory cleaning results due to relatively simple configurations, requiring frequent maintenance, limited service life, unreliable working performance, and requiring additional motors to provide working power.

### SUMMARY OF THE INVENTION

In view of the foregoing, the present disclosure provides an automatic step cleaning device for a passenger conveyor and a passenger conveyor, so as to solve or at least alleviate one or more of the aforementioned problems and other problems in the prior art, or to provide alternative technical solutions for the prior art.

According to a first aspect of the present disclosure, an automatic step cleaning device for a passenger conveyor is firstly provided, wherein a step chain is in transmission connection with a drive chain in the passenger conveyor to receive power from a drive portion for driving steps to operate, the automatic step cleaning device comprising: a base, arranged adjacent to a step that is in a flipped state during operation; a rotating shaft, mounted on the base and arranged in the drive chain to be driven to rotate synchronously with the step chain; and a first cleaning member, mounted on the rotating shaft and configured to perform a cleaning operation on the steps currently passing through the rotating shaft in the flipped state when the rotating shaft is driven to rotate.

In an automatic step cleaning device according to the present disclosure, optionally, the rotating shaft is perpendicular to a running direction of the steps, and the first cleaning member comprises a cleaning roller sleeved on the rotating shaft and having one or more sets of bristles extending outwardly along a peripheral direction.

In an automatic step cleaning device according to the present disclosure, optionally, the first cleaning member is configured such that the bristles perform the cleaning operation currently on only one step, or on two adjacent steps simultaneously.

In an automatic step cleaning device according to the present disclosure, optionally, the automatic step cleaning device further comprises: an accommodating member, configured to accommodate cleaned debris generated by the cleaning operation of first cleaning member on the steps; and/or a second cleaning member, configured to perform a cleaning operation on the first cleaning member.

In an automatic step cleaning device according to the present disclosure, optionally, the accommodating member is arranged below the rotating shaft, the first cleaning member comprises a cleaning roller sleeved on the rotating shaft and having one or more sets of bristles extending outwardly along a peripheral direction, the second cleaning member is mounted on the accommodating member and arranged parallel to the first cleaning member, and the second cleaning member is provided with comb teeth arranged to be oriented towards the bristles and to perform the cleaning operation when in contact with the bristles, such that the cleaned debris are disengaged from the bristles and fall into the accommodating member.

In an automatic step cleaning device according to the present disclosure, optionally, a length of the cleaning roller is not less than a width of a tread plate of the step, and/or a length of the portion of the second cleaning member configured with the comb teeth is not less than the length of the cleaning roller, and/or the comb teeth are arranged obliquely relative to a vertical direction and tip portion of each comb tooth is closer to the rotating shaft with respect to its root portion.

In an automatic step cleaning device according to the present disclosure, optionally, the second cleaning member is detachably connected to the accommodating member through one or more brackets, and the second cleaning member and the steps are respectively located on two sides of the rotating shaft.

In an automatic step cleaning device according to the present disclosure, optionally, the drive chain is configured as a circular chain, and the rotating shaft is provided with a sprocket for meshing with the circular chain to drive the rotating shaft to rotate, a rotation direction of the rotating shaft being opposite to a rotation direction of the step chain.

In an automatic step cleaning device according to the present disclosure, optionally, the automatic step cleaning device further comprises a shielding member arranged between the drive portion and the rotating shaft for at least partially shielding the first cleaning member.

In an automatic step cleaning device according to the present disclosure, optionally, the shielding member is configured in the shape of a plate and connected to the accommodating member and/or a truss of the passenger conveyor, and the accommodating member is configured to accommodate the cleaned debris generated by the cleaning operation of the first cleaning member on the steps.

In an automatic step cleaning device according to the present disclosure, optionally, the base comprises a bracket mounted on the truss of the passenger conveyor, and a bearing seat connected to the bracket for supporting the rotating shaft.

In an automatic step cleaning device according to the present disclosure, optionally, the drive portion is arranged near at least one turn-around area of the step chain, the drive portion including an electric motor.

According to a second aspect of the present disclosure, a passenger conveyor is further provided, comprising: a truss, installed fixedly on site; a guide rail and a step chain having a plurality of steps, wherein the guide rail is connected to the truss, and the step chain travels along the guide rail for carrying passengers; and the automatic step cleaning device according to any of the above, arranged in the passenger conveyor for performing a cleaning operation on the steps.

In a passenger conveyor according to the present disclosure, optionally, the passenger conveyor includes an escalator and a moving walk, and the automatic step cleaning device is arranged adjacent to one or more turn-around areas of the step chain.

In a passenger conveyor according to the present disclosure, optionally, the automatic step cleaning device is arranged in a machine space of an upper landing and/or a lower landing of the escalator.

The automatic step cleaning device of the present disclosure has many advantages such as compact structure, easy installation and maintenance, long service life and good cleaning effects. It can directly use the power in the passenger conveyor to automatically clean the steps without providing additional drive equipment. By virtue of the synchronous and reverse rotary movements between the cleaning member and the steps to be cleaned, the cleaning ability of the cleaning bristles on the steps can be effectively enhanced, thereby achieving highly efficient and satisfactory cleaning effect. The device has significant practicality and can be widely applied to various passenger conveyors such as escalators and moving walks.

### BRIEF DESCRIPTION OF THE DRAWINGS

The technical solutions of the present disclosure will be described in further detail below with reference to the accompanying drawings and embodiments. However, it should be understood that these drawings are designed merely for the purpose of explanation and only intended to conceptually illustrate the structures and configurations described herein, and are not required to be drawn to scale.

FIG. 1 is a three-dimensional structural schematic diagram of an example of an escalator according to the present disclosure.

FIG. 2 is a local side-view structural schematic diagram of an example of an automatic step cleaning device according to the present disclosure installed in the example of FIG. 1, wherein the example of an automatic step cleaning device is installed in the lower landing, with structures such as the second cleaning member and its bracket omitted.

FIG. 3 is a three-dimensional structural schematic diagram of a part of the example of an automatic step cleaning device shown in FIG. 2.

FIG. 4 is a three-dimensional structural schematic diagram of the assembled accommodating member and the second cleaning member in the example of the automatic step cleaning device shown in FIG. 2.

FIG. 5 is a local side-view structural schematic diagram after the accommodating member, the second cleaning member, and the shielding member in the example of the automatic step cleaning device shown in FIG. 2 are installed in place.

### DETAILED DESCRIPTION OF THE INVENTION

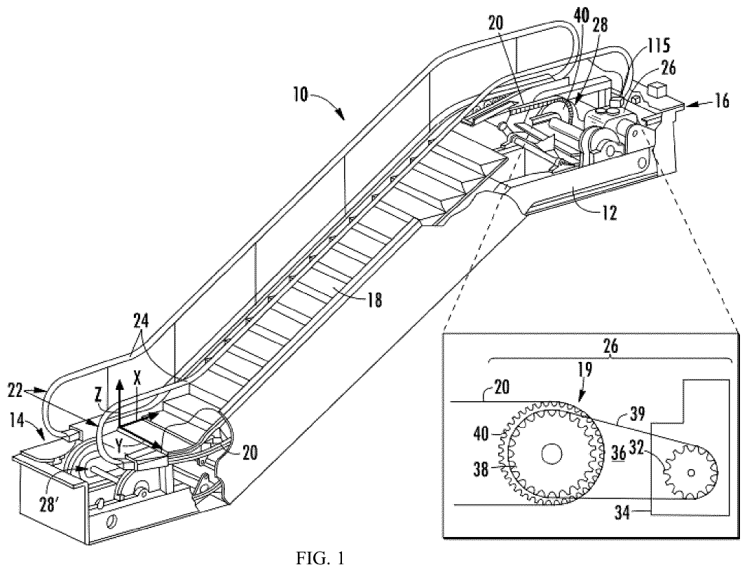

FIG. 1 illustrates an escalator 10. It should become apparent in the ensuing description that the present disclosure is applicable to other passenger conveyors, such as moving walks. The escalator 10 generally includes a truss 12 extending between a lower landing 14 and an upper landing 16, wherein the truss 12 is fixedly installed on site. A plurality of sequentially connected steps 18 are connected to a step chain 20 and travel through a closed loop path within the truss 12 along a guide rail fixedly connected onto the truss, thus forming a conveying section for carrying passengers. A pair of balustrades 22 includes moving handrails 24. A drive machine 26, or drive system, is typically located in a machine space 28 under the upper landing 16, or may be alternatively or additionally located in a machine space 28′ under the lower landing 14. The drive machine 26 is configured to drive the steps 18 and/or handrails 24 through the step chain 20. The drive machine 26 operates to move the steps 18 in a chosen direction at a desired speed under normal operating conditions.

The steps 18 make a 180 degree heading change in a turn-around area 19 located under the lower landing 14 and upper landing 16. The steps 18 are pivotally attached to the step chain 20 and follow a closed loop path of the step chain 20, running from one landing to the other, and back again.

The drive machine 26 includes a first drive member 32, such as motor output sheave, connected to a drive motor 34 through a belt reduction assembly 36 including a second drive member 38, such as an output sheave, driven by a drive chain 39, such as an output belt. The first drive member 32 in some embodiments is a driving member, and the second drive member 38 is a driven member.

As used herein, the first drive member 32 and/or the second drive member 38, in various embodiments, may be any type of rotational device, such as a sheave, pulley, gear, wheel, sprocket, cog, pinion, etc. The drive chain 39, in various embodiments, may be configured as a chain, belt, cable, ribbon, band, strip, or any other similar device that operatively connects two elements to provide a driving force from one element to another. For example, the drive chain 39 may be any type of interconnecting member that extends between and operatively connects the first drive member 32 and a second drive member 38. In some embodiments, as shown in FIG. 1, the first drive member 32 and the second drive member may provide a belt reduction. For example, first drive member 32 may be approximately 75 mm (2.95 inches) in diameter while the second drive member 38 may be approximately 750 mm (29.53 inches) in diameter. The belt reduction, for example, allows the replacement of sheaves to change the speed for 50 or 60 Hz electrical supply power applications, or different step speeds. However, in other embodiments, the second drive member 38 may be substantially similar to the first drive member 32.

As noted, the first drive member 32 is driven by drive motor 34 and thus is configured to drive the drive chain 39 and the second drive member 38. In some embodiments, the second drive member 38 may be an idle gear or similar device that is driven by the operative connection between the first drive member 32 and the second drive member 38 by means of drive chain 39. The drive chain 39 travels around a loop set by the first drive member 32 and the second drive member 38, which hereinafter may be referred to as a small loop. The small loop is provided for driving a larger loop which consists of the step chain 20, and is driven by an output sheave 40, for example. Under normal operating conditions, the drive chain 39 and the step chain 20 move in unison, based upon the speed of movement of the first drive member 32 as driven by the drive motor 34.

The escalator 10 also includes a controller 115 that is in electronic communication with the drive motor 34. The controller 115 may be located, as shown, in the machine space 28 of the escalator 10 and is configured to control the operation of the escalator 10. For example, the controller 115 may provide drive signals to the drive motor 34 to control the acceleration, deceleration, stopping, etc. of the steps 18 through the drive chain 39 and step chain 20. The controller 115 may be an electronic controller including a processor and an associated memory comprising computer-executable instructions that, when executed by the processor, cause the processor to perform various operations. The processor may be, but is not limited to, a single-processor or multi-processor system of any of a wide array of possible architectures, including field programmable gate array (FPGA), central processing unit (CPU), application specific integrated circuits (ASIC), digital signal processor (DSP) or graphics processing unit (GPU) hardware arranged homogenously or heterogeneously. The memory may be but is not limited to a random access memory (RAM), read only memory (ROM), or other electronic, optical, magnetic or any other computer readable medium.

Although described herein as a particular escalator drive system and particular components, this is merely exemplary, and those of skill in the art will appreciate that other escalator system configurations may operate with the invention disclosed herein.

One or more automatic step cleaning devices 50 may be configured in the escalator 10 according to application needs, for performing a cleaning operation on the steps. For example, they may be installed adjacent to one or more turn-around areas 19 of the step chain 20, such as in the machine space 28 of the upper landing 16 and/or the machine space 28′ of the lower landing 14. When the steps in the escalator 10 reach such positions, they usually make a turn, i.e., the tread plates of the steps will undergo a state of flipping from top to bottom. It should be appreciated that for the purpose of description herein, the technical terms “up”, “down”, “right”, “left”, “front”, “rear”, “vertical” and the derivatives thereof should be associated with the orientations as indicated in FIG. 1 of the present disclosure. However, unless explicitly stated otherwise, the present disclosure may adopt multiple alternative orientations.

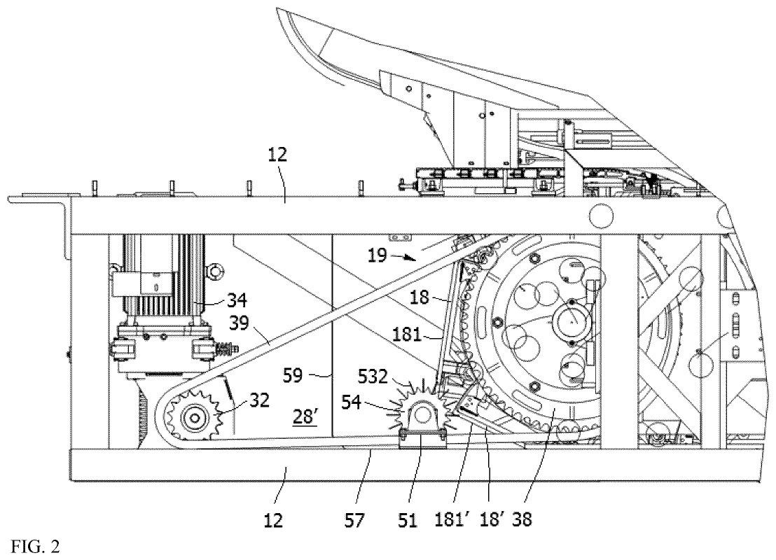

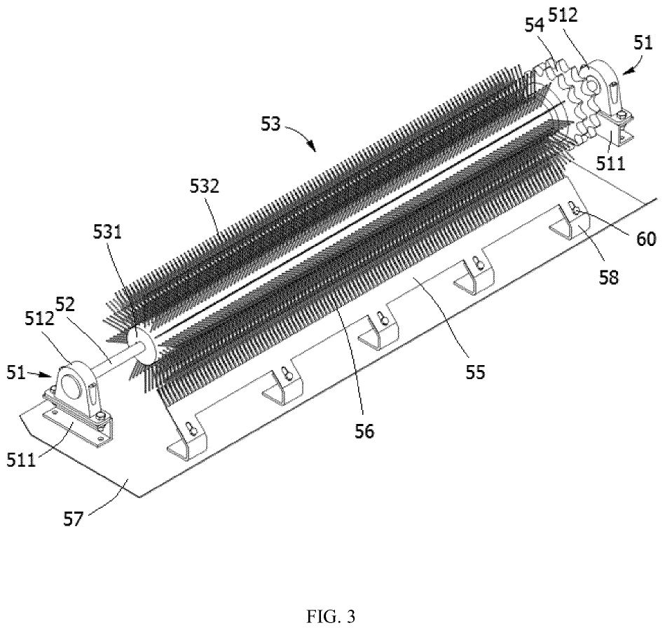

As an example, FIG. 2 specifically illustrates the general situation of arranging an automatic step cleaning device 50 in the machine space 28′ of the lower landing 14. As illustrated in FIG. 2, the automatic step cleaning device 50 may include a base 51, a rotating shaft 52 and a cleaning member 53. For the sake of simplification, another cleaning member 55, a bracket 58 and other structures as optional configurations are not shown in FIG. 2, but they are clearly shown in subsequent FIGS. 3 to 5.

The base 51 is used to support the rotating shaft 52, which may be installed adjacent to a step that is in a flipped state, such as fixed to the truss 12 or the working ground located in the machine space 28′ of the lower landing 14, in order to clean the steps passing through the rotating shaft 52 using the cleaning member 53 arranged on the rotating shaft 52.

Referring also to FIG. 3, as an example, the base 51 may be constructed with a bracket 511 and a bearing seat 512. According to practical application requirements, the bracket 511 may be installed in place in the expected position using any feasible connection methods, such as through the use of connecting members, welding, riveting, and the like. The bearing seat 512 is fixedly connected to the bracket 511, and is used to support the rotating shaft 52. For example, in FIG. 3, it is schematically shown that the bearing seat 512 may be arranged at both ends of the rotating shaft 52 to support the rotating shaft 52.

The rotating shaft 52 may be made of steel, iron, or other suitable materials. It may be arranged to be perpendicular to the running direction of the steps in the escalator 10 (the direction X shown in FIG. 1), and a driven component may be installed on the rotating shaft 52 and arranged in the transmission chain of the drive chain 39, so that when the drive motor 34 operates to provide power output, it can directly drive the rotating shaft 52 to rotate together. For example, FIG. 3 exemplarily illustrates that a sprocket 54 may be installed on the rotating shaft 52, wherein the sprocket 54 meshes with the drive chain 39 which is configured as a circular chain, thereby driving the rotating shaft 52 to continuously rotate synchronously with the cyclic movement of the drive chain 39. That is to say, the automatic step cleaning device 50 may be put into operation without the need for configuring additional drive equipment, and can rotate synchronously with the drive chain 39 and the step chain 20.

The cleaning member 53 may be sleeved on the rotating shaft 52 by means of, for example, key connections. More specifically, the cleaning member 53 may be configured with a cleaning roller 531 with bristles 532, where the bristles 532 extend outward along the peripheral direction of the cleaning roller 531. When the cleaning roller 531 is sleeved on the rotating shaft 52, the partially or completely flipped steps passing through the rotating shaft 52 may be cleaned by the bristles 532 to remove various possible objects to be cleaned on the steps (such as the tread plate area, step frame, etc.), such as particles, dust, stains, cigarette butts, food or package debris and other objects. For example, the length of the cleaning roller 531 may be configured to be not less than the width of the step tread plate (see the direction Y in FIG. 1), so as to allow for efficient step cleaning operation. Optionally, the bristles 532 may be made of, for example, non-metallic material or any other suitable material, such as nylon material, and the bristles 532 may be arranged in one or more sets as needed on the cleaning roller 531. When multiple sets of bristles are configured, not only can the cleaning effect be enhanced, but it can also help to extend the overall service life of the cleaning member.

In the automatic step cleaning device 50, by flexibly selecting and designing or adjusting some structural configurations, such as the installation positions of the base 51 and the rotating shaft 52, the diameter size of the cleaning roller 531, the length or layout of the bristles 532, etc., it is allowed to perform a cleaning operation on only one step or on two adjacent steps simultaneously. As an example, FIG. 2 illustrates that the bristles 532 on the cleaning member 53 of the automatic step cleaning device 50 may be used to clean the tread plate 181 of the step 18 and the tread plate 181′ of another adjacent step 18′, which helps to improve the work efficiency of the automatic step cleaning device and enhance the cleaning effect.

As used herein, in various embodiments, the rotating shaft 52 may be configured to rotate synchronously with the step chain 20. The rotation direction of the rotating shaft 52 is opposite to the rotation direction of the step chain 20. That is, the cleaning member and the steps to be cleaned can rotate synchronously and in the opposite direction. In this way, it can effectively increase the force exerted by the bristles of the cleaning member on the steps to be cleaned when they come into contact with them, thereby enhancing the cleaning ability and achieving better cleaning results.

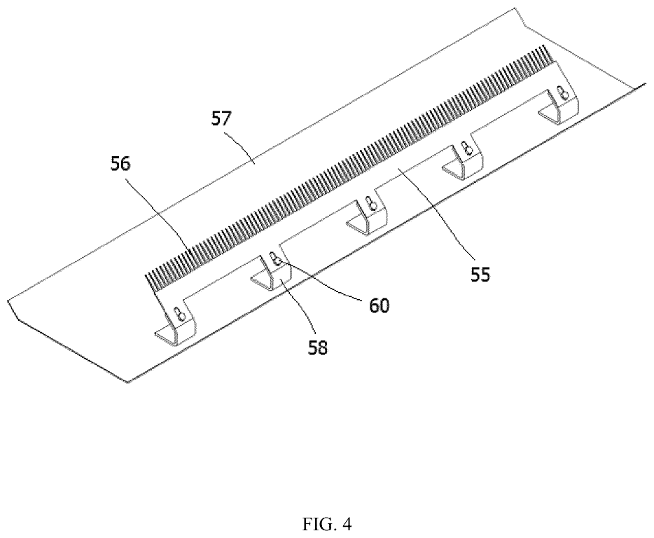

With continued reference to FIGS. 3, 4, and 5, the automatic step cleaning device 50 can optionally be configured with an accommodating member 57 to accommodate the cleaned debris generated by the cleaning member cleaning the steps, in order to facilitate subsequent processing of such cleaned debris, such as to clear the cleaned debris regularly or irregularly by the workers. As used herein, in various embodiments, the accommodating member 57 may be directly arranged below the rotating shaft 52 to facilitate the storage of the aforementioned cleaned debris. As exemplarily illustrated in FIG. 4, the accommodating member 57 may be constructed into a relatively simple but practical plate structure. Of course, it is also allowed by the present disclosure to configure the accommodating member to other suitable configurations as needed.

As used herein, in various embodiments, an additional cleaning member 55 can be configured in the automatic step cleaning device 50 to specifically clean the cleaning member 53, so that the cleaning member 53 itself can still be relatively clean after continuous use, thereby better completing the cleaning operation on the steps. For example, the example of FIG. 3 illustrates that the cleaning member 55 can be arranged parallel to the cleaning member 53 and configured with comb teeth 56. These comb teeth 56 are oriented towards the bristles 532 of the cleaning member 53, and can come into contact with the bristles when the rotating shaft 52 rotates, so that the cleaned debris that may stick to the bristles 532 can be cleaned off the bristles 532. For the cleaning member 55, it can be detachably mounted onto the accommodating member 57 through, for example, one or more brackets 58 and connecting members 60 (such as bolts, screws, etc.). When in use, the cleaned debris disengaged from the bristles 532 of the cleaning member 53 by the comb teeth 56 of the cleaning member 55 will fall into the accommodating member 57. The cleaned debris may then be removed and disposed of by workers, for example.

For the comb teeth 56 on the cleaning member 55, their specific structure, arrangement, etc. may be designed as needed, as long as they can achieve the cleaning effect on the bristles 532 of the cleaning member 53 as discussed above. For example, the cleaning member 55 may be configured such that these comb teeth 56 form an inclined arrangement relative to the vertical direction (the direction Z in FIG. 1) (such as forming 20 degrees, 30 degrees, 40 degrees, 60 degrees, 70 degrees or any other inclination as required for a specific application), and each tip of the comb tooth 56 facing outward is closer to the rotating shaft 52 as compared to its root, which will help the cleaned debris cleaned off from the bristles 532 to fall into the position between the cleaning member 53 and the cleaning member 55. That is, the cleaning member 55 will provide appropriate shielding for the cleaned debris to avoid outward diffusion and facilitate the collection of them. For another example, the length of the corresponding portion of the comb teeth 56 on the cleaning member 55 may be flexibly configured. For instance, it can usually be configured to have a length not less than the length of the cleaning roller 531, so that the cleaning member 53 can clean it throughout the entire length range of the cleaning roller 531 during each operation, thus improving work efficiency.

As used herein, in various embodiments, the cleaning member 55 may be arranged with respect to the steps 18 and 18′ on the other side of the rotating shaft 52, which facilitates the cleaning operation on the steps by the cleaning member 53 on that side. At the same time, the cleaning operation on the cleaning member 53 by the cleaning member 55 may be performed on the other side. Therefore, the opposite operations of firstly active cleaning by the cleaning element 55 and then passive cleaning for the cleaning element 55 can be completely achieved. The prior art has not considered and proposed the above at all. The present disclosure innovatively provides a cleaning operation for the cleaning members themselves that are used for cleaning the steps, thereby improving the step cleaning ability of the passenger conveyor to a higher level and with greater durability.

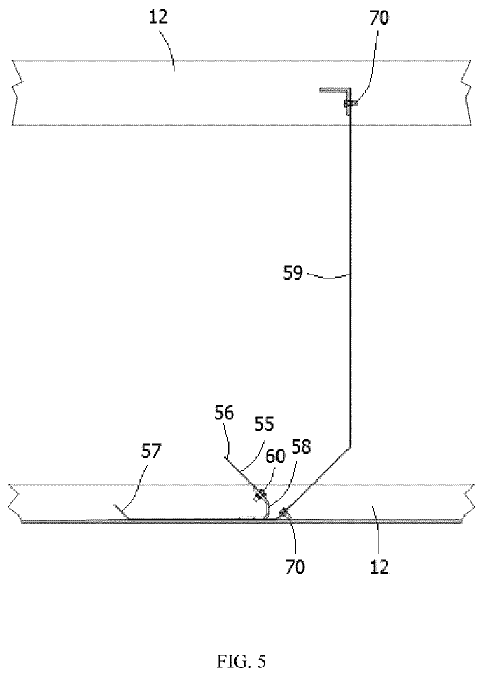

Referring to FIGS. 2 and 5, in the automatic step cleaning device 50, an additional shielding member 59 may be installed between the drive motor 34 and the rotating shaft 52 to at least partially shield the cleaning member 53 and the cleaning member 55 (if any), thereby reducing or eliminating the impact from the cleaned debris generated by the automatic step cleaning device 50 during the cleaning operation on the on-site equipment, such as on the drive motor 34. As an example, the shielding member 59 may be constructed into a plate shape or other suitable shape. As used herein, in various embodiments, the shielding member 59 may be connected to the truss 12 of the escalator and/or the aforementioned accommodating member 57, which may be achieved using any feasible connection method, such as through the use of connecting members 70 (such as bolts, screws, etc.), welding, riveting, and the like.

The specific structural composition and other aspects of the automatic step cleaning device 50 have been described by examples in the above, and the rotating shaft 52, the cleaning member 53, the cleaning member 55, the accommodating member 57, the shielding member 59, etc. have been exemplarily illustrated in the accompanying drawings. However, it should be noted that the present disclosure is not limited to these components and the structural constructions thereof. For example, in one or some embodiments, regardless of the cleaning member 53 or the cleaning member 55, they may be used individually or in combination with any suitable device such as a vacuum cleaner, hair dryer, dust sticky tape, etc., as long as they can be used to achieve the purpose of cleaning the steps of the passenger conveyor.

An automatic step cleaning device for a passenger conveyor and a passenger conveyor according to the present disclosure have been described above in detail by way of examples only. These examples are merely used to illustrate the principles and embodiments of the present disclosure, rather than limiting the present disclosure. Various modifications and improvements can be made by those skilled in the art without departing from the scope of the present disclosure. Therefore, all equivalent technical solutions should fall within the scope of the present disclosure and be defined by the claims of the present disclosure.

What is claimed is:

1. An automatic step cleaning device for a passenger conveyor, wherein a step chain is in transmission connection with a drive chain in the passenger conveyor to receive power from a drive portion for driving steps to operate, the automatic step cleaning device comprising:
a base, arranged adjacent to a step that is in a flipped state during operation;
a rotating shaft, mounted on the base and arranged in the drive chain to be driven to rotate synchronously with the step chain; and
a first cleaning member, mounted on the rotating shaft and configured to perform a cleaning operation on the steps currently passing through the rotating shaft in the flipped state when the rotating shaft is driven to rotate.

2. The automatic step cleaning device according to claim 1, wherein the rotating shaft is perpendicular to a running direction of the steps, and the first cleaning member comprises a cleaning roller sleeved on the rotating shaft and having one or more sets of bristles extending outwardly along a peripheral direction.

3. The automatic step cleaning device according to claim 2, wherein the first cleaning member is configured such that the bristles perform the cleaning operation currently on only one step, or on two adjacent steps simultaneously.

4. The automatic step cleaning device according to claim 1, wherein the automatic step cleaning device further comprises:
an accommodating member, configured to accommodate cleaned debris generated by the cleaning operation of first cleaning member on the steps; and/or
a second cleaning member, configured to perform a cleaning operation on the first cleaning member.

5. The automatic step cleaning device according to claim 4, wherein the accommodating member is arranged below the rotating shaft, the first cleaning member comprises a cleaning roller sleeved on the rotating shaft and having one or more sets of bristles extending outwardly along a peripheral direction, the second cleaning member is mounted on the accommodating member and arranged parallel to the first cleaning member, and the second cleaning member is provided with comb teeth arranged to be oriented towards the bristles and to perform the cleaning operation when in contact with the bristles, such that the cleaned debris are disengaged from the bristles and fall into the accommodating member.

6. The automatic step cleaning device according to claim 5, wherein a length of the cleaning roller is not less than a width of a tread plate of the step, and/or a length of the portion of the second cleaning member configured with the comb teeth is not less than the length of the cleaning roller, and/or the comb teeth are arranged obliquely relative to a vertical direction and tip portion of each comb tooth is closer to the rotating shaft with respect to its root portion.

7. The automatic step cleaning device according to claim 4, wherein the second cleaning member is detachably connected to the accommodating member through one or more brackets, and the second cleaning member and the steps are respectively located on two sides of the rotating shaft.

8. The automatic step cleaning device according to claim 1, wherein the drive chain is configured as a circular chain, and the rotating shaft is provided with a sprocket for meshing with the circular chain to drive the rotating shaft to rotate, a rotation direction of the rotating shaft being opposite to a rotation direction of the step chain.

9. The automatic step cleaning device according to claim 1, wherein the automatic step cleaning device further comprises a shielding member arranged between the drive portion and the rotating shaft for at least partially shielding the first cleaning member.

10. The automatic step cleaning device according to claim 9, wherein the shielding member is configured in the shape of a plate and connected to the accommodating member and/or a truss of the passenger conveyor, and the accommodating member is configured to accommodate the cleaned debris generated by the cleaning operation of the first cleaning member on the steps.

11. The automatic step cleaning device according to claim 1, wherein the base comprises a bracket mounted on the truss of the passenger conveyor, and a bearing seat connected to the bracket for supporting the rotating shaft.

12. The automatic step cleaning device according to claim 1, wherein the drive portion is arranged near at least one turn-around area of the step chain, the drive portion including an electric motor.

13. A passenger conveyor, comprising:
a truss, installed fixedly on site;
a guide rail and a step chain having a plurality of steps, wherein the guide rail is connected to the truss, and the step chain travels along the guide rail for carrying passengers; and
the automatic step cleaning device according to claim 1, arranged in the passenger conveyor for performing a cleaning operation on the steps.

14. The passenger conveyor according to claim 13, wherein the passenger conveyor includes an escalator and a moving walk, and the automatic step cleaning device is arranged adjacent to one or more turn-around areas of the step chain.

15. The passenger conveyor according to claim 14, wherein the automatic step cleaning device is arranged in a machine space of an upper landing and/or a lower landing of the escalator.
